(19) United States
(12) Patent Application Publication
(10) Pub. No.: US 2004/0233553 A1
(43) Pub. Date: Nov. 25, 2004

(54) Form variable mirror element and method for producing form variable mirror element and form variable mirror unit and optical pick-up

(75) Inventors: Hiroshi Shibata, Kasuya-gun (JP); Shougo Horinouchi, Fukuoka-shi (JP); Shogo Matsubara, Kasuga-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/849,257

(22) Filed: May 20, 2004

(30) Foreign Application Priority Data
May 21, 2003 (JP) 2003-143027

(51) Int. Cl. G02B 7/185

(52) U.S. Cl. 359/846

(57) ABSTRACT

To provide a form variable mirror element and a form variable mirror unit which are extremely thin with a simple structure and large in an amount of deformation even under low applied voltage, a form variable mirror element comprising: a form variable part including a piezoelectric film, a first electrode film and a second electrode film for supplying voltage to the piezoelectric film and a reflection mirror film provided in the piezoelectric film; and a base for supporting the form variable part. The form variable part is provided with an elastic unit forgiving elasticity to the form variable part. Thus, the films are laminated on the thin base by a thin film forming technique. Accordingly, the extremely thin form variable mirror element can be formed with a simple structure, so that a large amount of deformation can be effectively obtained even when low voltage is applied.

### BACKGROUND OF THE INVENTION

1. Field of the Invention

The present invention relates to a form variable mirror element, a method for producing a form variable mirror element and a form variable mirror unit and an optical pick-up in which prescribed voltage is applied to a piezoelectric film to vary the form of a reflection mirror surface.

2. Description of the Rrelated Art

As a usual form variable mirror element, a mirror element (for instance, see JP-A-5-127067) in which a mirror surface is pulled by a cable and an amount of pull is changed to change the mirror surface or a mirror element (for instance, see JP-A-7-311305) in which an elastic mirror surface is pressed from a back surface so that the mirror surface can be deformed to a concave surface, a convex surface and a plane surface or the like is disclosed. However, any of these form variable mirrors is adapted to vary the form of a mirror main body by a mechanical deforming mechanism and has a complicated structure to form optical parts with an extremely large size.

As the form variable mirror element with a small size, a mirror element (for instance, see JP-A-10-10459) in which a lead wire is soldered on a reflection mirror surface and an electrode film on the upper surface of a ceramic piezoelectric material is disclosed. However, since this form variable mirror element employs a bulky material as the piezoelectric material, the thickness of the piezoelectric material is very large. As a result, to vary the form of the form variable mirror element to a large size, a very high applied voltage is required.

As a form variable mirror element with a further micro size, a mirror element (for instance, see JP-A-2001-34993) having a piezoelectric film stuck to a reflection mirror plate is disclosed. As the reflection mirror plate, for instance, a glass reflector, a reflection film, a silicon wafer, etc. is used. This mirror element is also easily estimated to need an extremely high applied voltage. That is, the very thin glass reflector or the silicon wafer or the like is manufactured by a grinding or a highly accurate polishing operation or the like, however, a manufacture cost is high so that the very thin glass reflector or the silicon wafer is hardly manufactured. Further, the mirror element having the structure that the piezoelectric film is merely stuck to the reflection mirror is low in its mechanical strength, and accordingly, cannot be independent by itself. Thus, this mirror element is not suitable for a practical use. Accordingly, when the reflector, the reflection film, the silicon wafer or the like is practically used as the reflection mirror, a certain degree of thickness is required.

As the use of the form variable mirror element of the micro size, there is an optical pick-up for an optical recording and reproducing device for a compact disk (CD), a digital video disk (DVD), etc. as an information recording medium ordinarily using an optical disk. Since the DVD has a recording density higher than that of the CD, conditions required when information is read and written are strict. For instance, the optical axis of the optical pick-up is ideally perpendicular to the surface of the disk. Actually, since the disk is made of a resin, when the disk is strictly observed, the disk has a considerably curved surface. Accordingly, when the disk rotates, the optical axis of the optical pick-up is not always perpendicular to the surface of the disk. A recording layer of the optical disk is formed on the upper surface of a resin layer. Therefore, when the surface of the disk is not perpendicular to the optical axis of an objective lens, the optical path of light passing through the objective lens bends so that the spot position of the light shifts from a proper position to generate a wave surface aberration. Then, when this aberration exceeds an allowable value, the information cannot be properly recorded and reproduced.

As means for optically correcting the wave surface aberration, a wave surface correcting plate for correcting the wave surface aberration (for instance, see JP-A-5-144056) by varying the thickness of a single member of a transparent piezoelectric element is disclosed. However, according to this method, since high voltage is required to obtain a necessary displacement, this method cannot be applied to the optical pick-up or the like. As other means for optically correcting the wave surface aberration, a method that a mirror itself is deformed by a laminated type piezoelectric element to control a phase (for instance, see JP-A-5-333274) is disclosed. However, when this method is used for small parts such as the optical pick-up, wiring is inconveniently complicated and an attaching cost is undesirably increased. Even when the problem of the wiring can be solved, the laminated type piezoelectric element needs to be considerably miniaturized. This method is not easy in view of technique and cost.

### SUMMARY OF THE INVENTION

The present invention solves the problems of the form variable mirror element using the usual piezoelectric element. That is, it is an object of the present invention to provide a form variable mirror element and a form variable mirror unit which are extremely thin with a simple structure and large in an amount of deformation ever under low applied voltage.

It is a second object of the present invention is to provide a method for producing a form variable mirror element.

It is a third object of the present invention is to provide an optical pick-up on which wave surface aberration correcting means is mounted without greatly changing the structure of a usual optical pick-up.

In order to solve the above-described problems, a e form variable mirror element of the present invention has a structure that a thin base and films are laminated by a thin film forming technique. According to this structure, the form variable mirror element and the form variable mirror unit can be provided which are extremely thin with a simple structure and large in an amount of deformation even under low applied voltage.

Further, a method for producing a form variable mirror element of the present invention includes a step in which a thin base is not stuck to a part below a form variable part. According to this constitution, the method for producing the form variable mirror element having a large amount of deformation under low applied voltage can be provided. At the same time, a reflection mirror film on the surface of an electrode film to which a base surface is transferred to form a mirror or specular surface can be formed. Accordingly, the form variable mirror element high in its reflection factor can be provided.

Further, an optical pick-up of the present invention uses the form variable mirror element or the form variable mirror unit as wave surface aberration correcting means. According to this structure, the optical pick-up on which the wave surface aberration correcting means is mounted can be provided without greatly changing the structure of an optical system.

The invention defined in claim 1 concerns a form variable mirror element comprising: a form variable part including a piezoelectric film, a first electrode film and a second electrode film for supplying voltage to the piezoelectric film and a reflection mirror film provided in the piezoelectric film; and a base for supporting the form variable part. The form variable part is provided with an elastic unit for giving elasticity to the form variable part. Thus, the films are laminated on the thin base by a thin film forming technique. Accordingly, the extremely thin form variable mirror element can be formed with a simple structure, so that a large amount of deformation can be effectively obtained even when low voltage is applied.

The invention defined in claim 2 concerns a form variable mirror element according to claim 1 in which the first electrode film is provided on one surface of the piezoelectric film and the second electrode film is provided on the other surface. Thus, voltage can be assuredly applied to the piezoelectric film and the piezoelectric film can be efficiently deformed.

The invention defined in claim 3 concerns a form variable mirror element according to claim 1 in which at least one of the reflection mirror film, the first electrode film, the second electrode film and the base has the elasticity as the elastic unit. Since a member for giving elasticity may not be separately provided, the element itself has a simple structure to improve productivity.

The invention defined in claim 4 concerns a form variable mirror element according to claim 1 in which an elastic sheet film is separately provided as the elastic unit and the elastic sheet film is provided between the base and the reflection mirror film. Thus, since a member for exclusively applying elasticity is provided, the elasticity can be easily adjusted to obtain characteristics with good accuracy.

The invention defined in claim 5 concerns a form variable mirror element according to claim 1 in which an area of the base for supporting the form variable part is smaller than the area of the base. Thus, an attaching area to other members can be increased to increase an attaching strength.

The invention defined in claim 6 concerns a form variable mirror element according to claim 5, in which the reflection mirror film provided in the form variable part is extended onto the base and the reflection mirror film provided in the form variable part is formed integrally with the reflection mirror film provided in a part in which the form variable part is not disposed. Thus, the reflection mirror film can be provided on the entire surface of the base, so that the productively is outstandingly improved.

The invention defined in claim 7 concerns a form variable mirror element according to claim 1 in which the outer form of the form variable part is at least one form selected from a circular form, an elliptic form, a rectangular form, a polygonal form and a triangular form. Thus, the form variable part can be accurately formed.

The invention defined in claim 8 concerns a form variable mirror element according to claim 1, in which a plurality of form variable parts is formed on one base. Thus, a plurality of independent lights incident on the element can be respectively individually adjusted and one incident light can be partly adjusted.

The invention defined in claim 9 concerns a form variable mirror element according to claim 4, in which the elastic sheet film is made of a resin and the Youngs' modulus of the resin is located within a range of 1/100 to 1/10 as high as the Youngs' modulus of the piezoelectric film. Since the Youngs' modulus of the material of the elastic sheet film is adequately lower than that of the piezoelectric film, even when the thickness of the elastic sheet film is larger than that of the piezoelectric film, an amount of deformation can be effectively increased.

The invention defined in claim 10 concerns a form variable mirror element according to claim 1, in which the form variable part has a diaphragm structure formed in an opening part of a hollow part of the thin base. The form variable part has the diaphragm structure, so that the base for restricting the deformation of the form variable part is not located below the form variable part. Thus, an amount of deformation can be effectively extremely increased even under low applied voltage.

The invention defined in claim 11 concerns a form variable mirror element according to claim 10, in which the total of an internal stress of the films forming the form variable part is in a state of compressed and tensile stress and an amount of deformation of the form variable part due to the internal stress is ¼ or less as long as the wavelength of light used as a PV value. Thus, the internal stress of the films forming the form variable part is previously controlled to set the amount of deformation of the form variable part due to the internal stress to ¼ or less as long as an employed wavelength as the PV value. Accordingly, the surface of the reflection mirror can be formed in an ideally smoothed surface.

The invention defined in claim 12 concerns a form variable mirror element according to claim 11, in which the elastic sheet film is provided in the form variable part as the elastic unit and the thickness of the elastic sheet film is different depending on areas. Thus, the thickness of the elastic sheet film is previously uneven depending on the areas, so that the deformed form of the form variable part can effectively realize a desired form, for instance, a deformed form with a constantly stable curvature.

The invention defined in claim 13 concerns a form variable mirror element according to claim 11, in which the thickness of the piezoelectric film provided in the form variable part is different depending on areas. Thus, the thickness of the piezoelectric film is previously uneven depending on the areas, so that the deformed form of the form variable part can effectively realize a desired form, for instance, a deformed form with a constantly stable curvature.

The invention defined in claim 14 concerns a form variable mirror unit comprising: a form variable mirror element according to any one of claims 1 to 13 and an actuator for moving the form variable mirror element itself. The form variable mirror element is formed integrally with the actuator. Thus, when the form variable mirror element is finely moved by the actuator to attach the form variable mirror element to an optical system such as an optical pick-up, an attaching unevenness can be effectively easily corrected by the actuator.

The invention defined in claim 15 concerns a method for producing a form variable mirror element comprising: a step of bonding a thin base on which a piezoelectric film and a first electrode film or a second electrode film are formed to a base including a resin and a step of etching the thin base. A form variable part is transferred to and formed on the base including the resin. Thus, the form variable part is not directly restricted by the thin base, so that the form variable mirror element having a large amount of deformation can be formed even under low applied voltage. At the same time, a reflection mirror film is formed on the surface of the electrode film to which the base surface is transferred to have a state of a mirror surface, the form variable mirror element high in its reflection factor can be provided.

The invention defined in claim 16 concerns a method for producing a form variable mirror element comprising: a diaphragm forming step of etching a thin base to form a diaphragm and a reflection mirror film forming step of forming a reflection mirror film after the diaphragm forming step. This producing method is different from a bonding and transferring method. The diaphragm is directly formed on the base to simplify a producing step and effectively produce the form variable mirror element with high yield. At the same time, the reflection mirror film can be also formed on the surface of an electrode film to which a base surface is transferred to have a state of a mirror surface, the form variable mirror element high in its reflection factor can be provided.

The invention defined in claim 17 concerns a method for producing a form variable mirror element according to claim 16, in which the diaphragm forming step of etching the thin base to form the diaphragm includes two stages of etching processes including a first process of etching a half or more of the thickness of the thin base and a second process of etching the rest of the thickness. In the second process, the thin part is etched to form the diaphragm. Thus, unevenness in an etched from can be reduced to effectively form the diaphragm excellent in its dimensional accuracy.

The invention defined in claims 18 and 19 concerns an optical pick-up which is a device for recording or reproducing data on an optical disk and has a unit for correcting a wave surface aberration of a laser beam, in which the form variable mirror element according to any one of claims 1 to 13 or the form variable mirror unit according to claim 14 is used as the wave surface aberration correcting unit. Since the form variable mirror element or the form variable mirror unit can be attached to an optical system for the optical pick-up by the same treatment as that of a rise mirror. Accordingly, the structure of the optical system of the usual optical pick-up is not greatly changed and the wave surface correcting unit can be easily mounted.

### BRIEF DESCRIPTION OF THE DRAWINGS

FIG. 1 is a side sectional view of a form variable mirror element of the present invention.

FIG. 2 is a perspective view showing a reflection mirror surface side of the from variable mirror element.

FIG. 3 is a side sectional view showing an operation of the form variable mirror element.

FIG. 4 is a side sectional view showing an operation of the form variable mirror element.

FIG. 5 is a sectional view of the form variable mirror element showing producing processes of the form variable mirror element.

FIG. 6 is a side sectional view of a form variable mirror element of a second embodiment according to the present invention.

FIG. 7 is a perspective view showing a reflection mirror surface side of the from variable mirror element of the second embodiment according to the present invention.

FIG. 8 is a side sectional view showing an operation of the form variable mirror element of the second embodiment according to the present invention.

FIG. 9 is a side sectional view showing an operation of the form variable mirror element of the second embodiment according to the present invention.

FIG. 10 is a sectional view of the form variable mirror element showing producing processes of the form variable mirror element of the second embodiment according to the present invention.

FIG. 11 is a side sectional view of a form variable mirror element of a third embodiment according to the present invention.

FIG. 12 is a perspective view showing a reflection mirror surface side of the from variable mirror element of the third embodiment according to the present invention.

FIG. 13 is a side sectional view showing an operation of the form variable mirror element of the third embodiment according to the present invention.

FIG. 14 is a side sectional view showing an operation of the form variable mirror element of the third embodiment according to the present invention.

FIG. 15 is a sectional view of the form variable mirror element showing producing processes of the form variable mirror element of the third embodiment according to the present invention.

FIG. 16 is a side sectional view of a form variable mirror element of a fourth embodiment according to the present invention.

FIG. 17 is a perspective view showing a reflection mirror surface side of the from variable mirror element of the fourth embodiment according to the present invention.

FIG. 18 is a side sectional view showing an operation of the form variable mirror element of the fourth embodiment according to the present invention.

FIG. 19 is a side sectional view showing an operation of the form variable mirror element of the fourth embodiment according to the present invention.

FIG. 20 is a sectional view of the form variable mirror element showing producing processes of the form variable mirror element of the fourth embodiment according to the present invention.

FIG. 21 is a perspective view schematically showing the structure of a form variable mirror unit.

FIG. 22 is a diagram showing an optical system of an optical pick-up including the form variable mirror of the present invention.

FIG. 23 is a diagram showing a wiring structure of the form variable mirror element of the present invention.

FIG. 24 is a diagram showing a wring structure of a form variable mirror element of another embodiment according to the present invention.

FIG. 25 is a diagram showing a form variable mirror element of one embodiment according to the present invention.

FIG. 26 is a diagram showing a form variable mirror element of one embodiment according to the present invention.

FIG. 27 is a diagram showing a form variable mirror element of one embodiment according to the present invention.

### DESCRIPTION OF THE PREFERRED EMBODIMENTS

Now, embodiments of the present invention will be described below in more detail.

### First Embodiment

Now, a first embodiment of a form variable mirror element according to the present invention will be described below by referring to the drawings. However, lead wires or terminals for applying voltage or the like which are not directly related to the present invention are not shown in the drawings. Further, the thickness of films or the thickness of a base, an amount of deformation or the like in the drawings is different from an actual dimension for the purpose of easy understanding. The above-described things are applied to all the below-described drawings.

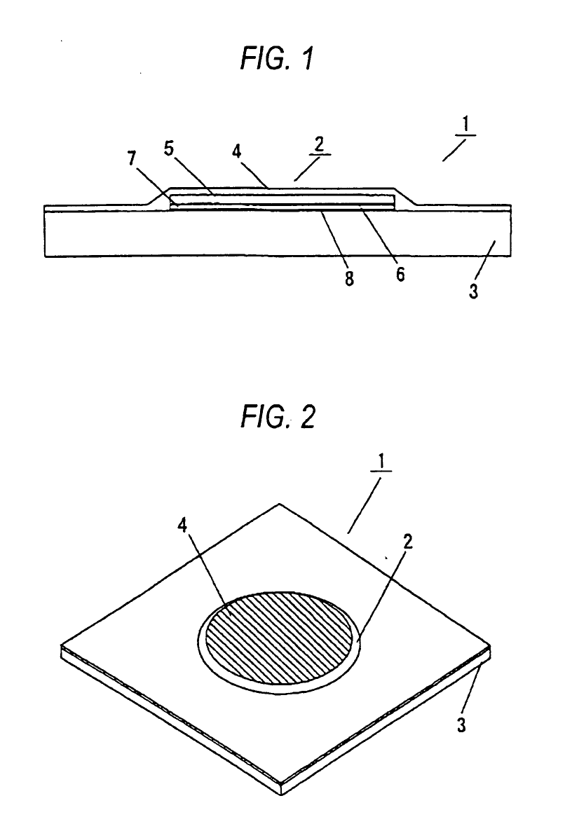

FIG. 1 is a side sectional view of the form variable mirror element according to the present invention.

FIG. 2 is a perspective view showing a reflection mirror surface side of the form variable mirror element of the present invention.

The form variable mirror element 1 comprises at least a form variable part 2 and a base 3 for supporting the form variable part 2.

The base 3 supports the form variable part 2. The form variable part 2 includes, in order from an upper surface, a reflection mirror film 4, an elastic sheet film 5 for determining a deforming direction or a deformed form or the like, a first electrode film 6 for applying voltage to a piezoelectric film 7, the piezoelectric film 7 for deforming the form variable part 2 by expansion and another second electrode film 8 for applying voltage to the piezoelectric film 7.

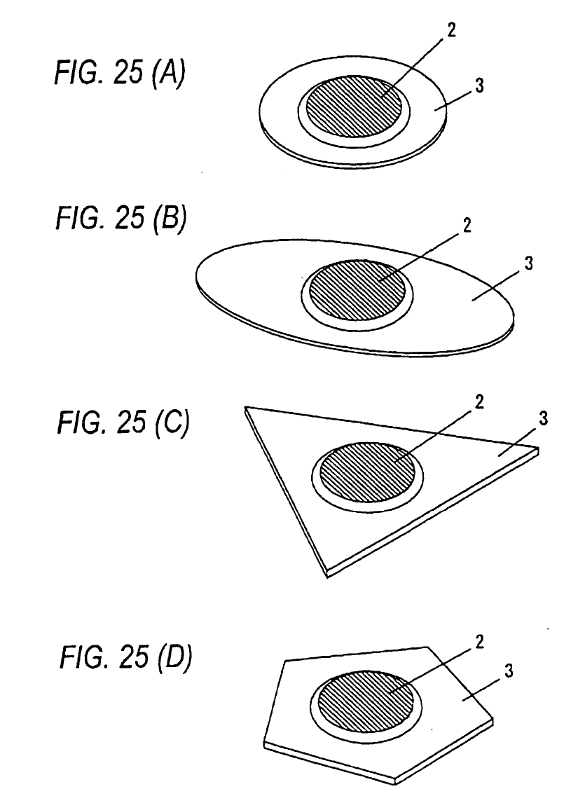

As a material of the base 3, since the piezoelectric characteristics of the piezoelectric film 7 tend to be improved by a mono-crystal material such as Si or MgO. However, the material of the base is not especially limited thereto. When a high temperature process is used in a process for manufacturing the form variable mirror element 1, the base 3 is preferably made of a material good in its heat resistance. In this embodiment, as the base 3, a single plate or a single sheet type member made of the same material is used. However, the single plates or the single sheet type members made of the same material may be laminated by using an adhesive agent or the like. The single plates or the single sheet type members made of different materials may be laminated. Further, as the base 3, a base having a coating applied to the surface of a base member made of an insulating or electric conductive material may be used. As the outer form of the base 3, a rectangular form is used in this embodiment. However, a circular form, an elliptic form, a polygonal form or a triangular form may be used. That is, as shown in FIGS. 25(A) to 25(D), the form of the base 3 is changed by a specification or the like, so that attaching characteristics can be effectively improved or an attaching area can be effectively reduced.

As a material of the piezoelectric film 7, a material such as perovskite oxide including PZT or Pb akin to PZT which is high in its piezoelectric constant and large in its displacement is preferably employed.

A method for forming the piezoelectric film 7 includes many methods, for instance, a sputtering method, a deposition method, a CVD method or a sol gel method. However, any method by which a thin film can be formed may be used without a special limitation.

A material of the elastic sheet film 5 is not limited to a specific material and materials such as a resin, metal, ceramics, etc. maybe employed. In this embodiment, chromium or chromium alloy is used as the material of the elastic sheet film 5. When the base 3 itself is made of an elastic material, the base 3 has a function of the elastic sheet film. Accordingly, the elastic sheet film 5 is not necessarily required.

A method for forming the elastic sheet film 5 also includes many methods, for instance, a sputtering method, a CVD method, a deposition method, etc. However, any technique by which a thin film can be formed may be used without a special limitation.

As a material of the reflection mirror film 4, a metal film such as Au, Al or Ag having a high reflection factor or an alloy film having a high reflection factor may be used. Further, a dielectric multi-layer film may be preferably employed. Assuming that the wavelength of light desired to be reflected is λ, the dielectric multi-layer film is formed by alternately laminating a λ/4 film having a high refractive index and a λ/4 film having a low refractive index. As a material of the dielectric multi-layer film, for instance, TiO₂ or Ta₂O₅ is preferably used for the film with the high refractive index. As the film with the low refractive index, for instance, Sio₂ or MgF₂ are preferably employed. In the present invention, TiO₂ is employed as the film with the high refractive index is used and SiO₂ is used as the film with the low refractive index. Assuming that one layer of the SiO₂ film (a dielectric film with a low refractive index) and one layer of TiO₂ film (a dielectric film with a high refractive index) formed in close contact with the film are considered to be one period, 3 to 40 periods are preferably formed from the viewpoints that the reflection factor is increased and the thickness is decreased. The periods are increased to laminate the dielectric multi-layer films, so that the reflection factor is increased. In such a way, the periods of the dielectric multi-layers are increased or decreased to adjust a desired reflection factor.

A method for forming the reflection mirror film 4 includes many methods, for instance, a sputtering method, or a deposition method, etc. like the method for forming the piezoelectric film 7. However, any technique by which a thin film can be formed may be used without a special limitation.

As a material of the first and second electrode films 6 and 8, metal having a high electric conductivity is preferably used. When a process using a high temperature process is employed in a step for forming the form variable mirror element 1, a material such as Pt, Ir or alloys thereof strong for high temperature are desirable. A method for forming the first and second electrode films 6 and 8 includes many methods, for instance, a sputtering method, or a deposition method, etc. like the method for forming the piezoelectric film 7. However, any technique by which a thin film can be formed may be used without a special limitation.

The material of the first electrode film 6 may be different from that of the second electrode film 8. The first and second electrode films 6 and 8 maybe respectively formed by laminating electric conductive films made of respectively different materials. Further, the laminated structure of the first electrode film 6 may be made different from the laminated structure of the second electrode film 8 in such a way that the first electrode film 6 has a single layer and the second electrode film 8 has a multi-layer structure. A method for externally applying voltage to the first and second electrode films 6 and 8 will be described below.

As shown in FIG. 2, the form variable part 2 is provided on a part of the base 3 so that the light desired to reflect can be substantially reflected on the form variable part 2. That is, in this embodiment, the form variable part 2 is provided at a substantially central part of the base 3 having an area larger than that of the form variable part 2. Thus, when the form variable mirror element 1 is attached to other member, an attaching area can be increased and an attaching strength or the like can be increased. Further, the incident area of the light incident on the form variable mirror element 1 is smaller than the formed area of the form variable part 2. Thus, the reflecting direction of the incident light can be assuredly changed. Even when the area of the incident light is slightly larger than that of the form variable part 2, desired characteristics can be obtained.

Further, in this embodiment, to simplify processes in production, the reflection mirror 4 is provided integrally on the form variable part 2 and the surface of the base 3 on which the form variable part 2 is provided. However, the reflection mirror film 4 may be provided on at least a surface on which the light is incident (at least a part of the form variable part 2). The reflection mirror film 4 is preferably provided on the entire part of the form variable part 2. Further, the reflection mirror film 4 may be provided to slightly protrude from the form variable part 2.

As described above, when the reflection mirror film 4 is provided in at least the form variable part 2 and in the vicinity of a part including the form variable part 2, the reflection mirror film 4 is partly provided by using a method such as a patterning method or an etching method.

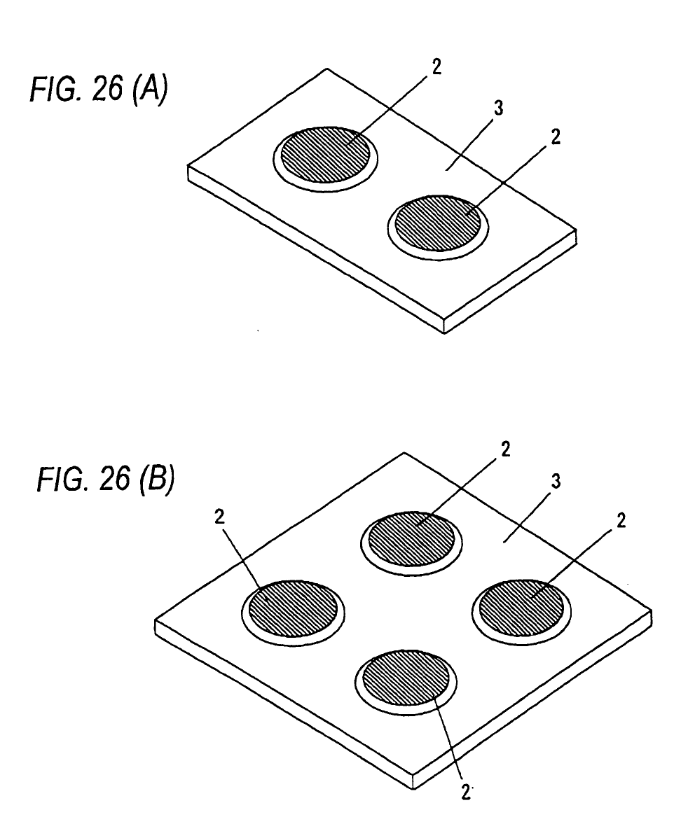

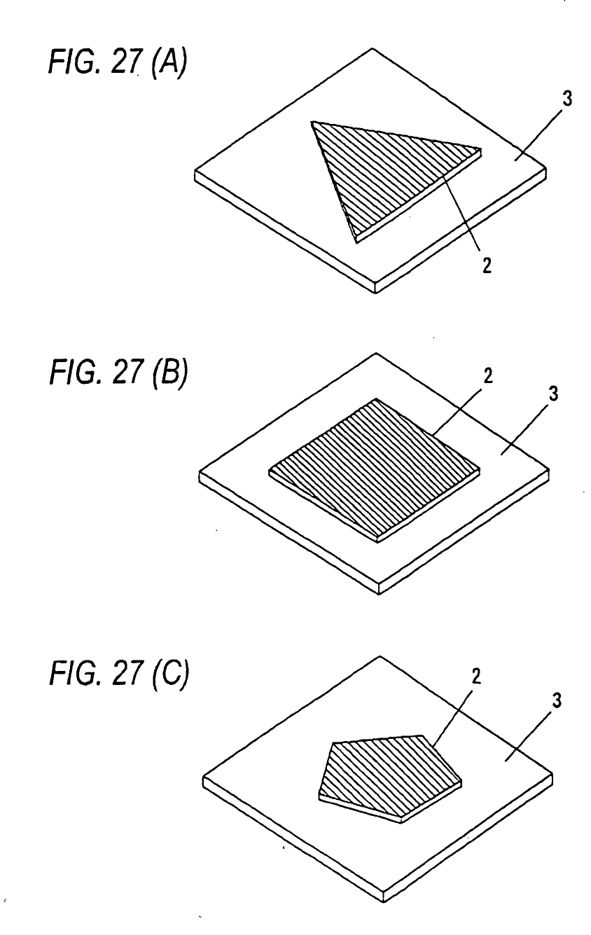

In this embodiment, only one form variable part 2 is provided on the base 3. However, as shown in FIG. 26(A) and FIG. 26(B), a plurality of form variable parts 2 may be provided on one base 3. FIG. 26 shows examples in which two form variable parts 2 and four form variable parts 2 are provided. It is to be recognized that five or more of the form variable parts 2 maybe provided and odd number of form variable parts may be provided. The number of the form variable parts 2 to be provided can be suitably determined by a specification or the like. According to the above-described construction, a first form variable part and a second form variable part mounted on the one base 3 can have different variations, for instance, the wavelength of respectively reflected lights can be made different from each other, or the first form variable part and the second form variable part are irradiated with the same light to change reflecting directions. That is, when the plurality of form variable parts 2 are provided, they maybe respectively synchronously operated, or they may be respectively independently operated. Further, as the form of the form variable part 2, a circular form is employed. However, a polygonal form such as a triangular form, a square form, a pentagonal form as shown in FIGS. 27(A) to 27(C) may be used. These forms may be suitably changed by a specification or the like.

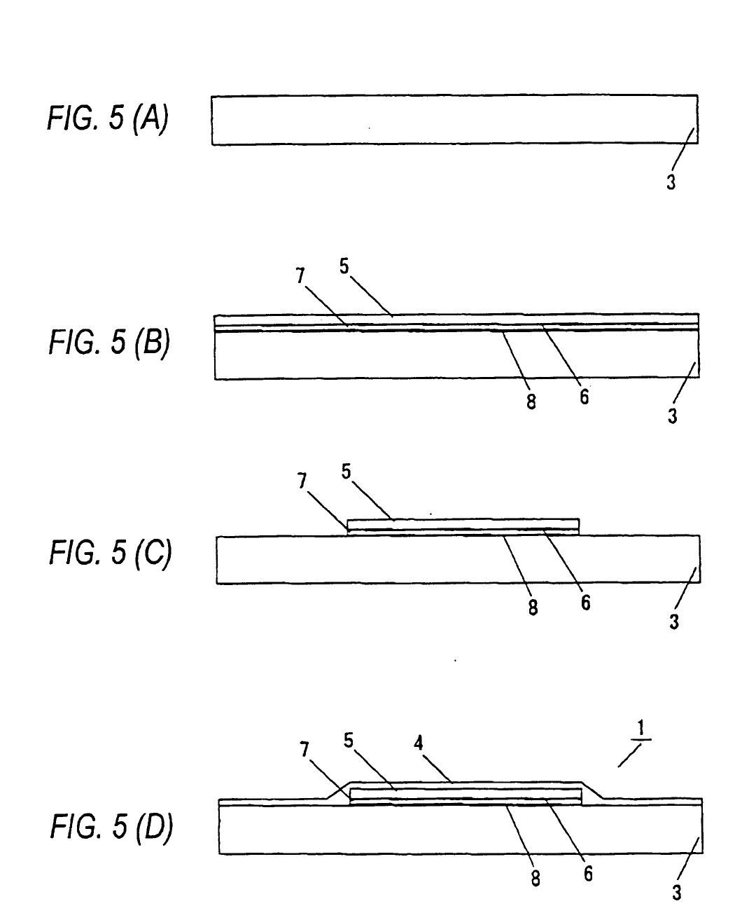

A method for producing the form variable mirror element according to this embodiment will be described by referring to the drawings. FIG. 5 is a sectional view of the form variable mirror element showing that shows producing processes of the form variable mirror element.

Firstly, as shown in FIGS. 5(A) and 5(B), the second electrode film 8, the piezoelectric film 7, the first electrode film 6 and the elastic sheet film 5 are sequentially formed on the thin Si base 3 having the thickness of 200 μm to 400 μm. As a material of the second electrode film 8, Ir is used. For the first electrode film 6, Au/Ti is used. The thickness of each of the electrode films 6 and 8 is set to 0.05 μm to 0.1 μm. As a material of the piezoelectric film 7, PZT is used. The thickness of PZT is set to 1 μm to 5 μm. As a material of the elastic sheet film 5, Cr excellent in its adhesion or corrosion resistance is used. The thickness of Cr is set to 1 μm to 3 μm. In forming the films, Au/Ti films of the first electrode film are formed by sequentially forming an Au film and a Ti film from a base 3 side by the deposition method and other films are formed by the sputtering method.

Then, as shown in FIG. 5(C), the laminated films such as the elastic sheet film 5 are processed to desired forms by a photolithography method and the etching method.

Finally, as shown in FIG. 5(D), the reflection mirror film 4 is formed. In this embodiment, as the reflection mirror film 4, 20 layers of λ/4 films composed of SiO₂/TiO₂ are formed by the deposition method. Thus, the form variable mirror element 1 is completed.

Although an explanation and an illustration are not made, insulating films are respectively formed between the films as required. For instance, when the Si base having a relatively high electric conductivity is used as the base 3, the insulating film may be formed between the second electrode film 8 and the base 3. When the metal film is used as the elastic sheet film 5, the insulating film may be formed between the first electrode film 6 and the elastic sheet film 5. For instance, to ensure insulating characteristics, a film such as silica may be formed between the base 3 and the second electrode film 8. As described above, when the base 3 is formed with the Si base, the surface of silicon may be oxidized to form an insulating layer. As described above, the characteristics of the component material of each film are made a good use of without providing a separate film to form the insulating film under a heat treatment or a chemical treatment. Thus, the insulating film can be more simply formed and the processes can be simplified to improve productivity.

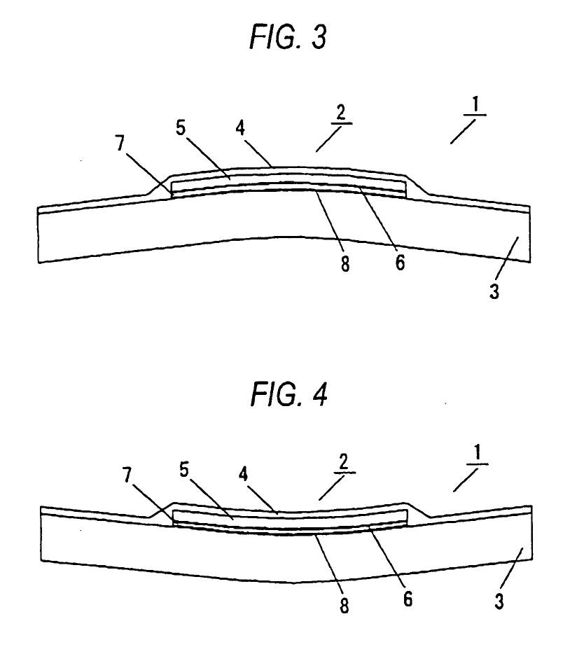

An operation of the form variable mirror element constructed as described above will be described by way of the drawings. FIGS. 3 and 4 are side sectional views showing the operation of the form variable mirror element 1. When voltage is applied to the first electrode film 6 and the second electrode film 8 of the form variable mirror element 1, for instance, a sectional form shown in FIG. 3 is obtained. When voltage having an opposite polarity is respectively applied to the individual electrode films 6 and 8, a sectional form shown in FIG. 4 is obtained. When voltage is applied to the piezoelectric film 7, the piezoelectric film 7 expands and contracts. Accordingly, assuming that when the voltage of a positive polarity is applied to the first electrode film 6, the piezoelectric film 7 in a part to which the voltage is applied expands, when the voltage of a negative polarity is applied, the piezoelectric film 7 in a part to which the voltage is applied contracts. As a result, when the voltage of the positive polarity is applied to the first electrode film 6, the surface of a reflection mirror becomes a convex surface as shown in FIG. 3. On the contrary, when the voltage of the negative polarity is applied to the first electrode film 6, the surface of the reflection mirror becomes a concave surface as shown in FIG. 4.

As described above, the form variable mirror element of the first embodiment of the present invention is formed with the thin base and the laminated films, so that a thin element with an extremely simple structure can be formed. Consequently, the form variable mirror element having a large amount of deformation can be realized even under low applied voltage.

### Second Embodiment

Now, a second embodiment of a form variable mirror element according to the present invention will be described by referring to the drawings.

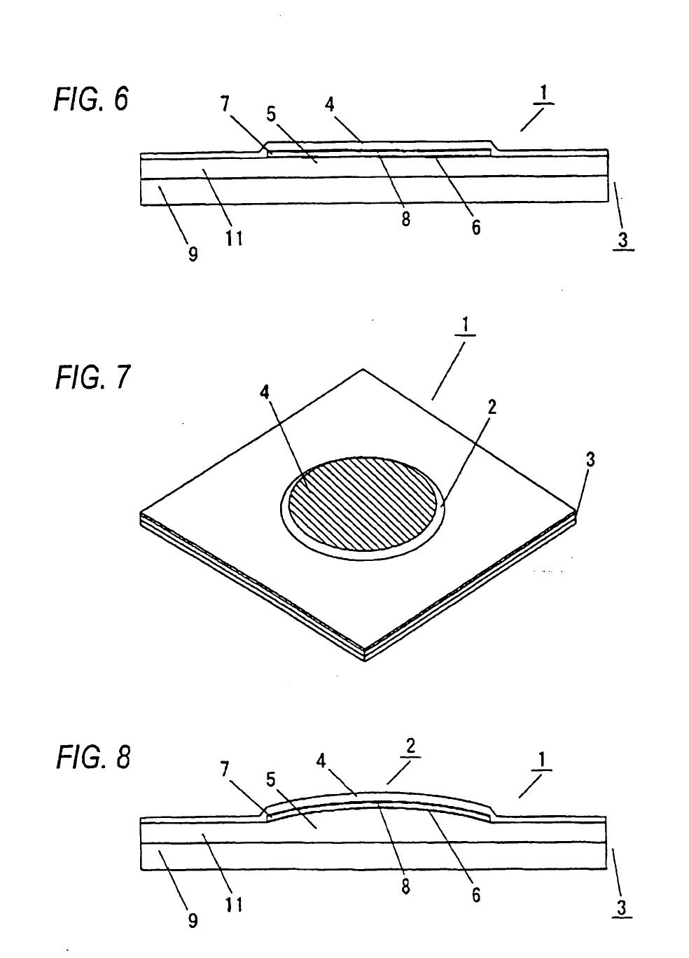

FIG. 6 is a side sectional view of the form variable mirror element of the second embodiment according to the present invention.

FIG. 7 is a perspective view showing a reflection mirror surface side of the form variable mirror element of the second embodiment according to the present invention.

Parts that are not especially specifically described below are the same as those of the first embodiment.

The form variable mirror element 1 includes at least a form variable part 2 and a base 3 for supporting the form variable part 2.

The base 3 supports the form variable part 2 and comprises, for instance, a glass base 9 and a resin layer 11. The form variable part 2 includes a reflection mirror film 4, a second electrode film 8 for applying voltage to a piezoelectric film 7, the piezoelectric film 7 for deforming the form variable part 2 by expansion and contraction, another first electrode film 6 for applying voltage to the piezoelectric film 7 and an elastic sheet film 5 for determining a deforming direction or a deformed form, etc. from an upper surface. In this embodiment, since the resin layer 11 has the function of the elastic sheet film 5 shown in the first embodiment, the elastic sheet film 5 is the same as the resin layer 11.

The materials used in the second embodiment are substantially the same as those of the first embodiment. The difference of the second embodiment from the first embodiment resides in that the glass base 9 and the resin layer 11 are used as the base 3. The glass base 9 is not especially limited to a glass material. Any material whose surface is smooth and preferably has a mirror surface may be employed. As a material of the resin layer 11, a material having Youngs' modulus of about 1/100 to 1/10 as high as the Youngs' modulus of the piezoelectric film and high in its elasticity may be employed.

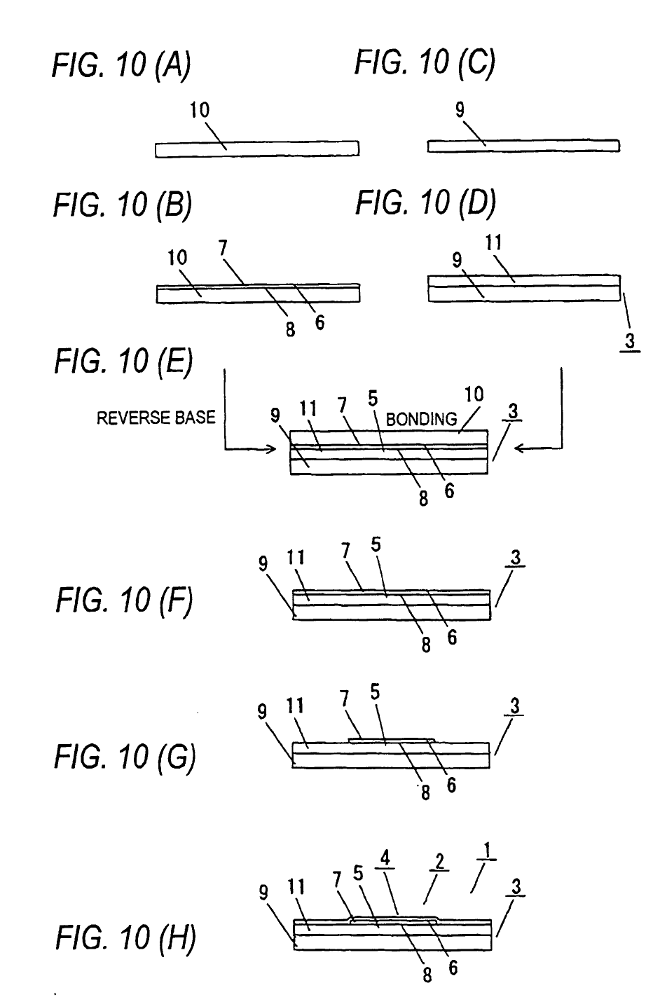

A method for producing the form variable mirror element of the second embodiment will be described by referring to the drawings. FIG. 10 is a sectional view of the form variable mirror element that shows producing processes of the form variable mirror element of the second embodiment according to the present invention.

This embodiment is characterized in that two kinds of bases are used. That is, a first base 10 for forming the piezoelectric film 7 and a base (a glass base 9) for supporting the form variable mirror element 1 are used. Both the bases are bonded together during the producing processes and the first base 10 forming the piezoelectric film 7 is removed by etching or the like.

Initially, as shown in FIGS. 10(A) and 10(B), the second electrode film 8, the piezoelectric film 7 and the first electrode film 6 are formed on the first base 10. As a material of the first base 10, MgO mono-crystal is used. In parallel therewith, as shown in FIGS. 10(C) and 10(D), the resin layer 11 is formed on the glass base 9. As a material of the glass base 9, glass is used. However, a sheet material made of other material may be used. As a material of the resin layer 11, polyimide is used, however, other material may be used. The resin layer 11 is formed by applying and burning liquid polyimide resin.

Then, as shown in FIG. 10(E), the film surface of the first base 10 faces the surface of the resin layer 11 made of polyimide of the glass base 9 and is bonded to thereto. As an adhesive material used for bonding, an epoxy resin type adhesive agent is employed, however, other material may be used. Then, the first base 10 as the MgO base is completely removed by etching using aqueous phosphoric acid solution. Thus, the laminated films on the first base 10 as the MgO base are transferred to the base 3 (including the glass base 9 and the resin layer 11). After that, at least the laminated films are processed to desired forms by a photolithography and etching. Consequently, on the lower surface of the piezoelectric film 7, soft epoxy resin or polyimide resin (the resin layer 11 has a function of the elastic sheet film 5) are arranged. Thus, a restriction to the piezoelectric film 7 is reduced relative to the glass base 9 or the first base made of the MgO base 10. These resins have suitable hardness, so that wiring layers for the piezoelectric film 7 (the first and second electrode films 6 and 8) are not prevented from being formed. Finally, a reflection mirror film 4 is formed on the second electrode film 8 to complete the form variable mirror element 1.

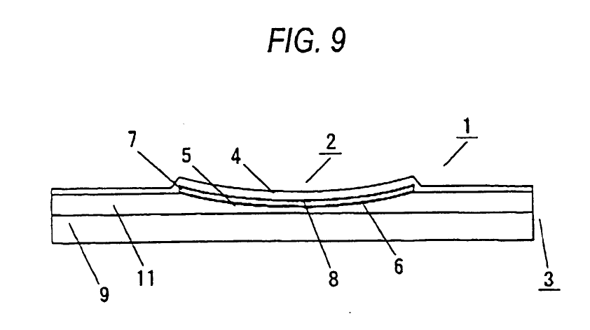

An operation of the form variable mirror element 1 constructed as described above will be described by way of the drawings. FIGS. 8 and 9 are side sectional views showing the operation of the form variable mirror element of the second embodiment. When voltage is applied to the first electrode film 6 and the second electrode film 8 of the form variable mirror element 1, for instance, a sectional form shown in FIG. 8 is obtained. When voltage having an opposite polarity is respectively applied to the first and second electrode films 6 and 8, a sectional form shown in FIG. 9 is obtained. When voltage is applied to the piezoelectric film 7, the piezoelectric film 7 expands and contracts. Accordingly, assuming that when the voltage of a positive polarity is applied to the first electrode film 6, the piezoelectric film 7 in a part to which the voltage is applied expands, when the voltage of a negative polarity is applied, the piezoelectric film 7 in a part to which the voltage is applied contracts. As a result, when the voltage of the positive polarity is applied to the first electrode film 6, the glass base 9 is not substantially deformed as shown in FIG. 8. However, the form variable part 2 is deformed so as to expand the soft resin (the resin layer 11) high in its elasticity. Consequently, the reflection surface of the reflection mirror film 4 becomes a convex surface. On the contrary, when the voltage of the negative polarity is applied to the first electrode film 6, the glass base 9 is not substantially deformed as shown in FIG. 9. However, the form variable part 2 is deformed so as to press and contract the soft resin (the resin layer 11). As a result, the reflection surface of the reflection mirror film 4 becomes a concave surface as shown in FIG. 9.

As described above, in the form variable mirror element 1 of the second embodiment, the resin layer 11 made of polyimide or the like is formed between the glass base 9 and the form variable part 2 Thus, the form variable part 2 is not bound by the glass base 9 high in its rigidity and bound by the resin layer 11. Since the resin is rich in its elasticity, the restraining force of the form variable part 2 is lower than that of the glass base 9. As a result, the form variable part 2 can be efficiently deformed even under low applied voltage so that the form variable mirror element 1 having a large amount of deformation can be realized.

Further, in a method for producing the form variable mirror element of this embodiment, since the reflection mirror film 4 is formed on the surface of the second electrode film 8 to which the smoothness of the glass base 9 is transferred to obtain a mirror surface state, the from variable mirror element 1 with an extremely high reflection factor can be realized.

### Third Embodiment

Now, a third embodiment of a form variable mirror element according to the present invention will be described by referring to the drawings.

FIG. 11 is a side sectional view of the form variable mirror element of the third embodiment according to the present invention.

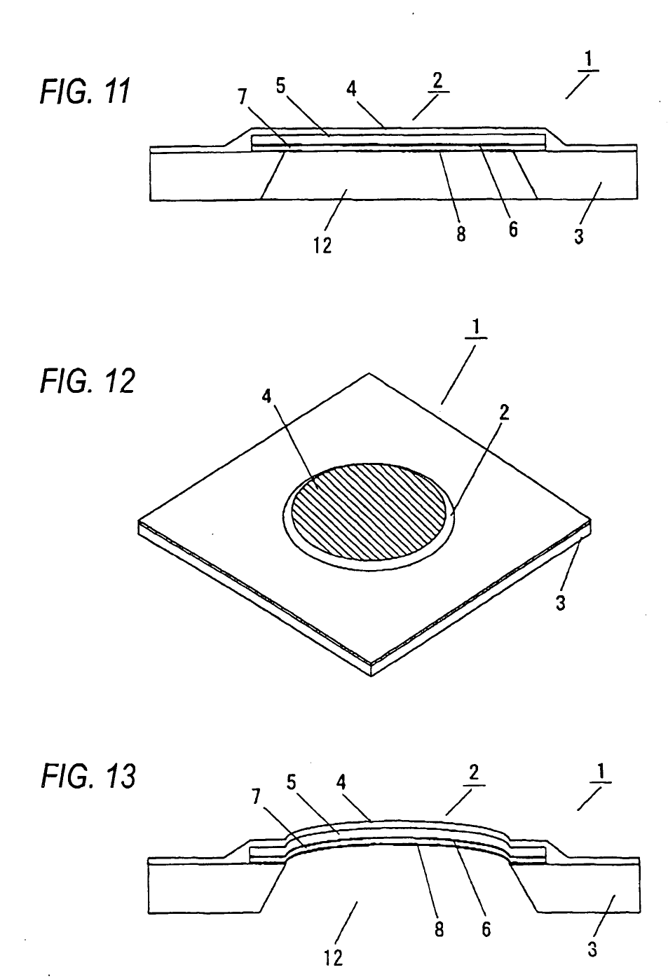

FIG. 12 is a perspective view showing a reflection mirror surface side of the form variable mirror element of the third embodiment according to the present invention.

Parts that are not especially specifically described below are the same as those of the first embodiment.

A feature of the form variable element of the third embodiment resides in that a form variable part 2 has a diaphragm structure.

The form variable mirror element 1 includes at least the form variable part 2 and a base 3 for supporting the form variable part 2.

As the base 3, an Si base is used and has a structure for supporting the periphery (a peripheral edge part) of the form variable part 2. The inner peripheral part of the form variable part 2 has the diaphragm structure. The form variable part 2 includes a reflection mirror film 4, a first electrode film 6 for applying voltage to a piezoelectric film 7, the piezoelectric film 7 for deforming the form variable part 2 by expansion and contraction, another second electrode film 8 for applying voltage to the piezoelectric film 7 and an elastic sheet film 5 for determining an amount of deformation or a deformed form, etc. from an upper surface.

Materials used in the third embodiment are substantially the same as those of the first embodiment.

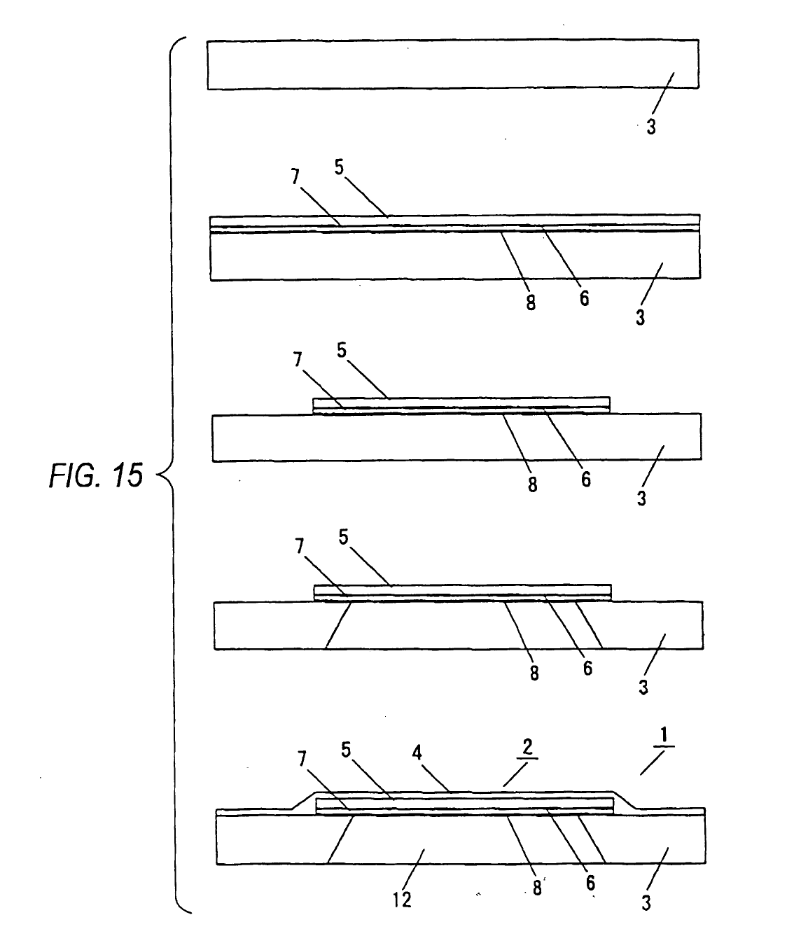

Now, a method for producing the form variable mirror element 1 of the third embodiment will be described below. FIG. 15 is a sectional view of the form variable mirror element that shows producing processes of the form variable mirror element of the third embodiment according to the present invention. The feature of the producing processes of this embodiment resides in that abase etching process is included to have the form variable part with the diaphragm structure.

Firstly, as shown in FIGS. 15(A) and 15(B), on the base 3 composed of Si or including Si and having both surfaces on which oxide films are formed, the second electrode film 8, the piezoelectric film 7, the first electrode film 6 and the elastic sheet film 5 are sequentially formed. As a material of the second electrode film 8, Ir is used. For the first electrode film 6, Au/Ti is used. The thickness of each of the electrode films is set to 0.1 μm. As a material of the piezoelectric film 7, PZT is used. The thickness of PZT is set to 3 μm.

Then, as shown in FIG. 15(C), the elastic sheet film 5 is processed to a desired form by a photolithography method and the etching method.

Then, the reflection mirror film 4 is formed. In the third embodiment, the reflection mirror film 4 is formed. In the third embodiment, as the reflection mirror film 4, 20 layers of λ/4 films composed of SiO₂/TiO₂ are formed.

Finally, as shown in FIG. 15(D), to form a diaphragm 12, the Si base used as the base 3 is etched. On the back surface of the Si base used as the base 3, a mask pattern for etching composed of an Si oxide film is formed. After that, the Si base is subjected to an etching process to a desired depth by using etching solution such as KOH solution or a reactive ion etching method (RIE) from the back surface of the Si base. Thus, the form variable part 2 becomes the diaphragm 12. In such a way, the form variable mirror element 1 is completed. In the method for producing the form variable mirror element of this embodiment, after the reflection mirror film 4 is formed, the diaphragm 12 is formed. However, both the processes may be reversed without any difficulty. Further, in this embodiment, when the diaphragm 12 is formed, a hole whose diameter of section is gradually decreased from the back surface of the base 3 toward the front surface is provided. However, a hole whose diameter of section does not change may be provided to form the diaphragm 12.

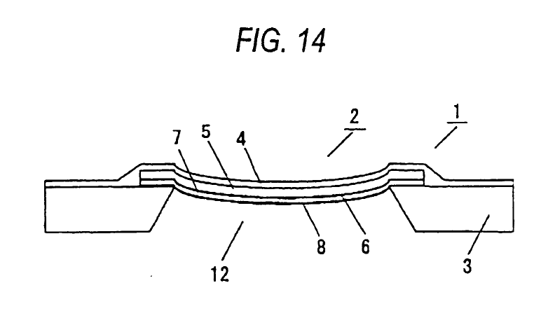

An operation of the form variable mirror element 1 constructed as described above is shown in FIGS. 13 and 14. FIGS. 13 and 14 are side sectional views showing the operation of the form variable mirror element of the third embodiment according to the present invention. The explanation of the operation is the same as that of the first embodiment, and accordingly, the explanation of the operation is omitted herein. According to the form variable mirror element 1 of the third embodiment of the present invention, the form variable part 2 has the structure of the diaphragm 12, the form variable part 2 is not restrained by the base 3. As a result, the form variable part 2 can be more efficiently deformed even under low applied voltage. Thus, the form variable mirror element 1 having an extremely large amount of deformation can be realized.

In the form variable mirror element 1 of this embodiment, the internal stress of the laminated films including the diaphragm 12 is more preferably adjusted. All the films forming the form variable mirror element 1 have the internal stress. When the total of the internal stress of the laminated films forming the form variable part 2 composed of the diaphragm 12 constitutes a tensile stress relative to the base 3, a more excellent form variable element 1 can be realized. That is, when the diaphragm 12 is formed, the internal stress is released in the laminated films composed of the diaphragm 12. When the laminated films have a tensile stress within an elastic limit, the laminated films composed of the diaphragm 12 act to contract by themselves. As a result, the diaphragm 12 is formed under a state excellent in its flatness without bending.

Further, when the laminated films have a compressive stress, the laminated films composed of the diaphragm 12 act to expand by themselves. As a result, the diaphragm 12 is liable to be bent and be formed under a deformed state poor in its flatness. Further, when the compressive stress is very high, the diaphragm 12 is greatly bent. Thus, the form variable mirror element may not sometimes function as the form variable mirror element 1. When the laminated films are formed under a stress value in which an amount of bending deformation of the form variable part 2 due to the compressive stress is not higher than ¼ as long as using wavelength as a PV value, the reflection surface of the reflection mirror film 4 has an ideal mirror surface. Accordingly, the total of the internal stress of the laminated films forming the form variable mirror element 1 is previously controlled, so that the amount of deformation of the form variable part 2 due to the internal stress can realize the value not higher than ¼ as long as the using wavelength as the PV value. Thus, a practically extremely excellent form variable mirror element 1 can be realized.

As another method for producing the form variable mirror element of the third embodiment, the reflection mirror film 4 is formed on surface of the elastic sheet film 5. Further, when the reflection mirror film 4 is formed on the surface of the second electrode film 8, a more practically preferable form variable mirror element 1 can be realized. That is, when the electrode films 6 and 8 or the elastic sheet film 5 or the like are laminated in multi-layers, the surfaces of the films are roughened. Thus, when the reflection mirror film 4 is formed on the surface of the second electrode film 8 to which the mirror surface of the base 3 is transferred to have a mirror surface, the form variable mirror element 1 having the extremely high reflection factor can be realized.

Further, as other method for producing the form variable mirror element of this embodiment, a diaphragm forming step may be divided into two processes. For instance, a half or more as large as the thickness of the base 3 is etched by a first diaphragm forming process. The remaining part is etched by a second diaphragm forming process to form the diaphragm 12. Ordinarily, since the deformed form of the form variable mirror element 1 is affected by the form of the diaphragm 12, an accurate etching process is required. However, since the Si base used as the base 3 ordinarily has the thickness of about 300 to 500 μm, an etching mask pattern is extremely hardly formed from the back surface of the base 3 to accurately process the dimensional form of a front surface. When the diaphragm forming step is divided into the two processes, since the diaphragm 12 is not formed in the first process, a processing accuracy may below. Further, in the second diaphragm forming process, the processing accuracy needs to be high to form the diaphragm 12. However, the thickness itself of the base 3 to be etched is previously decreased, so that the etching process with a good dimensional accuracy can be realized.

### Fourth Embodiment

A fourth embodiment of a form variable mirror element according to the present invention will be described by referring to the drawing.

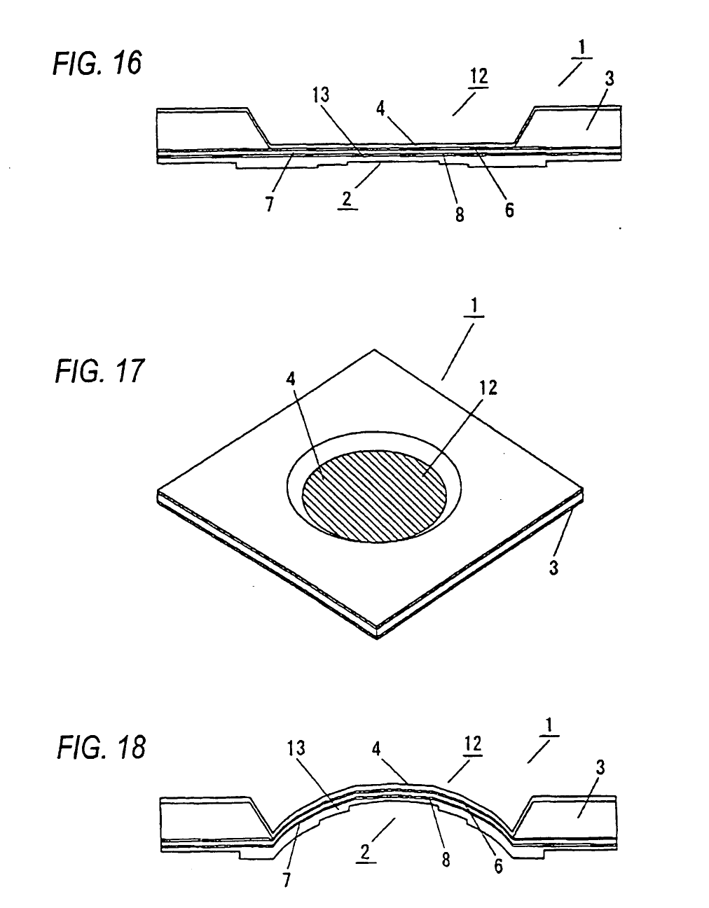

FIG. 16 is a side sectional view of the form variable mirror element of the fourth embodiment according to the present invention.

FIG. 17 is a perspective view showing a reflection mirror surface side of the form variable mirror element of the fourth embodiment according to the present invention.

Parts that are not especially specifically described below are the same as those of the first embodiment.

A feature of the form variable mirror element of the fourth embodiment resides in that the thickness of an elastic sheet film of a form variable part is not uniform.

The form variable mirror element 1 includes at least the form variable part 2 and a base 3 for supporting the form variable part 2.

The base 3 is composed of an Si base or the like and has a structure for supporting the periphery of the form variable part 2. The inner peripheral part of the form variable part 2 has a diaphragm structure. The form variable part 2 includes a reflection mirror film 4, a first electrode film 6 for applying voltage to a piezoelectric film 7, the piezoelectric film 7 for deforming the form variable part by expansion and contraction, another second electrode film 8 for applying voltage to the piezoelectric film 7 and an irregular elastic sheet film 13 formed by processing an elastic sheet film 5 for determining a deforming direction or a deformed form, etc. from an upper surface. Materials used in the fourth embodiment are substantially the same as those of the first embodiment.

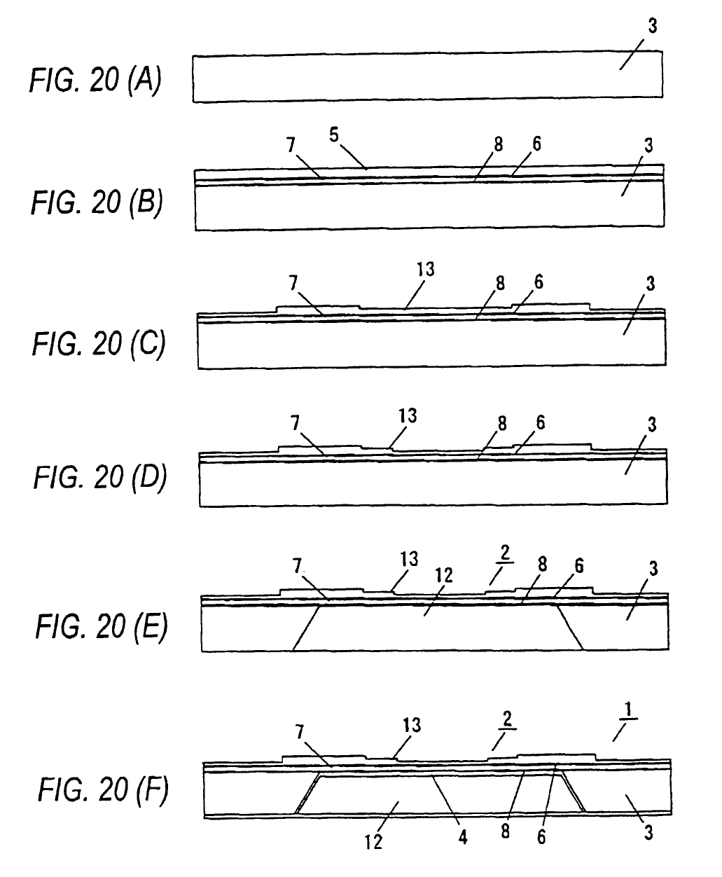

Now, a method for producing the form variable mirror element of the fourth embodiment will be described below. FIG. 20 is a sectional view of the form variable mirror element that shows producing processes of the form variable mirror element of the fourth embodiment according to the present invention. The feature of the producing processes of this embodiment resides in that the thickness of the diaphragm of the form variable part 2 is etched by a plurality of processes.

Firstly, as shown in FIGS. 20(A) and 20(B), on the base 3 composed of Si and having both surfaces on which Si oxide films are formed, the second electrode film 8, the piezoelectric film 7, the first electrode film 6 and the elastic sheet film 5 are sequentially formed.

As a material of the second electrode film 8, Ir is used. For the first electrode film 6, Au/Ti is used. The thickness of each of the electrode films is set to 0.1 μm. As a material of the piezoelectric film 7, PZT is used. The thickness of PZT is set to 3 μm.

Then, as shown in FIGS. 20(C) and 20(D), the elastic sheet film 5 is processed to a desired form by a photolithography method and the etching method. In this embodiment, to provide a prescribed curvature in a deformed form, the thickness of the concentrically outer peripheral part of the elastic sheet film 5 is large and the thickness of the concentrically inner peripheral part is small. Further, the elastic sheet film 5 is processed by two processes. Further, as the etching method, a reactive ion etching method (RIE) is used to etch the elastic sheet film to a desired depth. The elastic sheet film 5 is etched as described above to form the irregular elastic sheet film 13.

Then, as shown in FIG. 20(E), to form a diaphragm 12, on the back surface of the Si base used as the base 3, a mask pattern for etching composed of an Si oxide film is formed. After that, the Si base is subjected to an etching process to a desired depth by using etching solution such as KOH solution or the reactive ion etching method (RIE) from the back surface of the Si base. Thus, the form variable part 2 becomes the diaphragm 12 in the Si base.

Finally, as shown in FIG. 20(F), the reflection mirror film 4 is formed. In the fourth embodiment, as the reflection mirror film 4, 20 layers of λ/4 films composed of SiO₂/TiO₂ are formed. Thus, the form variable mirror element 1 is completed.

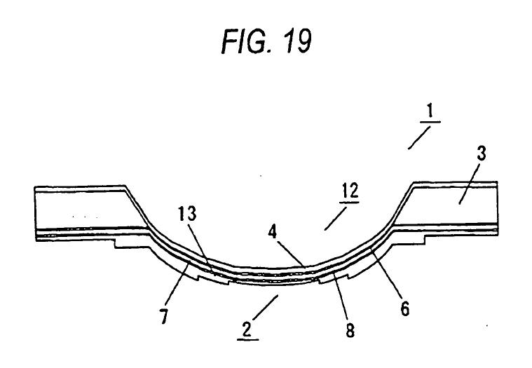

An operation of the form variable mirror element 1 constructed as described above is shown in FIGS. 18 and 19. FIGS. 18 and 19 are side sectional views showing the operation of the form variable mirror element of the fourth embodiment according to the present invention. The explanation of the operation is the same as that of the first embodiment, and accordingly, the explanation of the operation is omitted herein. In the form variable mirror element 1 of the third embodiment, the deformed form of the form variable part 2 is an elliptic circular arc shape as shown in FIGS. 13 and 14. On the other hand, in the form variable mirror element 1 of the fourth embodiment, the deformed form of the form variable part 2 is a circular arc shape as shown in FIGS. 18 and 19.

In the form variable mirror element 1 of the fourth embodiment, the thickness of the elastic sheet film 5 is uneven to control the deformed form of the form variable part 2. However, the deformed form may be controlled by making the thickness of the piezoelectric film 7 uneven.

Further, it is to be understood that the thickness of both the piezoelectric film 7 and the elastic sheet film 5 maybe made uneven to form a deformed configuration having a further degree of freedom.

As described above, according to the form variable mirror element 1 of the fourth embodiment, since the thickness of the elastic sheet film 5 or the piezoelectric film 7 is uneven to adjust the thickness of the film to a suitable thickness so as to obtain a preset curvature, the deformed configuration with a constantly stable curvature can be realized. For instance, since the wave surface of a laser beam can be controlled, a focusing operation with good converging characteristics can be realized in a stable manner. Further, since the diameter of the laser beam can be controlled to decrease or increase, the focusing position of the laser beam can be varied in a stable manner.

### Fifth Embodiment

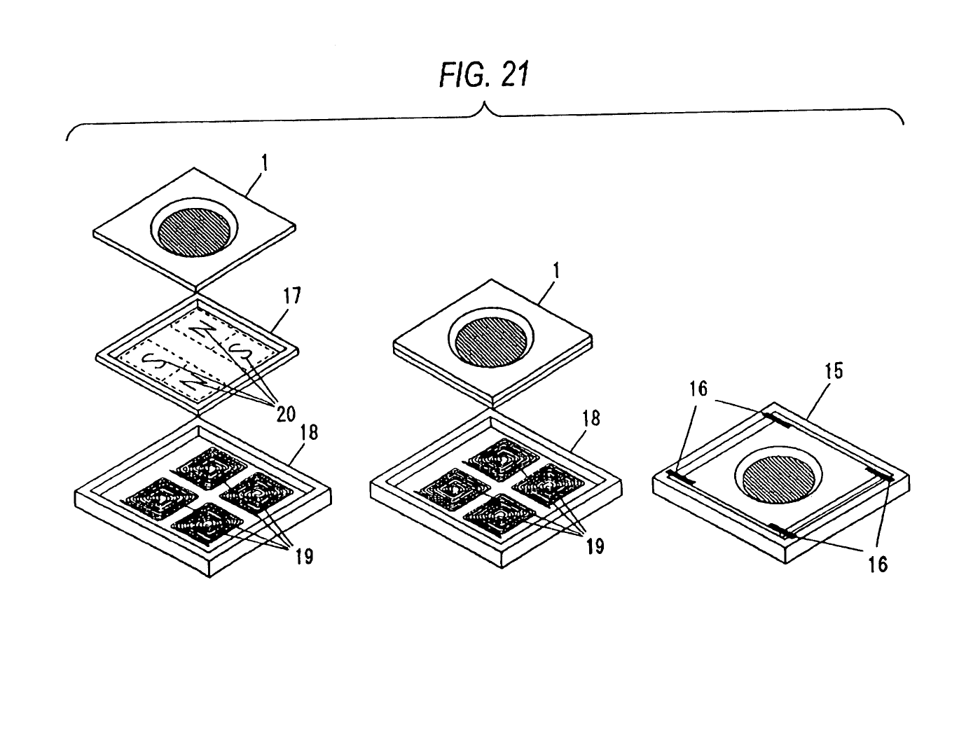

A form variable mirror unit of a fifth embodiment according to the present invention will be described by referring to the drawings. FIG. 21 is a perspective view schematically showing the structure of the form variable mirror unit. In the form variable mirror unit 15, a form variable mirror element 1 is formed as a movable part that is float-supported by elastic members 16. More specifically, the form variable mirror unit 15 includes the form variable mirror element 1, abase 17 for supporting and fixing the form variable mirror element 1 and a casing 18 for float-supporting the form variable element 1 and the base 17 by the elastic members 16.

An actuator of the form variable mirror unit 15 in this embodiment is a voice coil motor. Coils 19 are provided in the casing 18 and serve as magnetic flux giving means. Permanent magnets 20 are fixed to the back surface of the base 17. Accordingly, in the form variable mirror unit 15, electric current is supplied to the coils 19 so that the form variable mirror element 1 itself can operate. In this embodiment, a driving mechanism only in the direction of height is shown, however, the form variable mirror element may move in directions of two axes or more depending on a method for supporting the elastic members 16 and the arrangement of the coils and the magnets.

As described above, according to the form variable mirror unit 15 of the present invention, when the form variable mirror unit is attached to an optical system of an optical pick-up, unevenness in attaching can be easily corrected by the actuator.

In the fifth embodiment, the permanent magnets 20 are mounted on the base 17 and the coils 19 are mounted on the casing 18. However, conversely, the permanent magnets 20 may be mounted on the casing 18 and the coils 19 may be mounted on the base 17.

### Sixth Embodiment

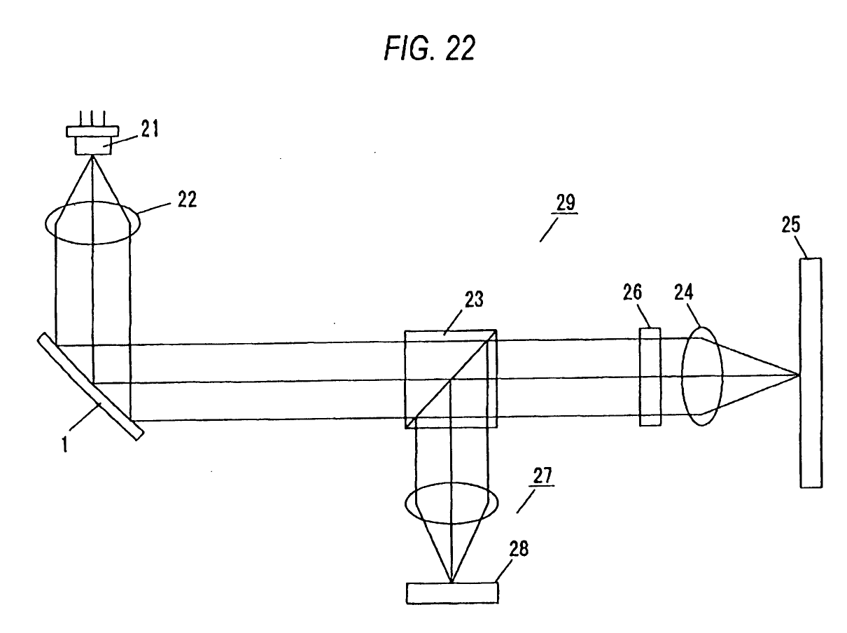

An optical pick-up of a sixth embodiment according to the present invention will be described by referring to the drawings. FIG. 22 is a diagram showing the optical system of the optical pick-up including a form variable mirror according to the present invention.

In the optical pick-up 20 having the above-described structure, laser beams emitted from a laser element 21 are converted into parallel lights by a collimator lens 22. The parallel lights are reflected by the form variable mirror element 1, pass through a deflecting beam splitter 23, converged on an objective lens 24 and focused on an optical disk 25. The laser beams reflected from the optical disk 25 pass through the objective lens 24, a λ/4 plate 26 and the deflecting beam splitter 23, and are converged on a photo-detecting optical system 27 and detected by a photo-detecting element 28. This detecting element 28 includes a detecting element for detecting a tilt.

In this optical system, when the optical disk 25 is inclined from a position perpendicular to the optical axis of the laser beam, the wave surface of the laser beam reflected and returning from the optical disk is disturbed to generate a wave surface aberration (a coma aberration). That is, when the optical disk is perpendicular to the optical axis of the laser, the wave surface does not include an aberration as shown in the drawing. However, the wave surface aberration generated when the disk is tilted is directly included in the reflected light. In this case, the form variable mirror element 1 is previously deformed more only by the wave surface aberration to generate the wave surface aberration in the laser beams. Thus, the laser beams whose phases are aligned are converged on a focal point on a recording surface of the optical disk. Thus, the wave surface aberration can be reduced.

In this embodiment, as a wave surface aberration correcting element, the form variable mirror element 1 is used. However, when the form variable mirror unit 15 is used, a degree of freedom in an aberration correction control is more increased so that a more accurate recording and reproduction can be realized.

Further, when the thickness of a protective film of the optical disk is uneven, the wave surface aberration (coma aberration) is generated. Also in this case, the form variable mirror element is previously deformed more only by the wave surface aberration, so that the wave surface aberration can be reduced.

According to the optical pick-up of the present invention, since a size is small with a simple structure, the optical system of the optical pick-up can be attached by a similar treatment to that of a rise mirror. As a result, the optical pick-up on which wave surface aberration correcting means is mounted can be realized without greatly changing a structure.

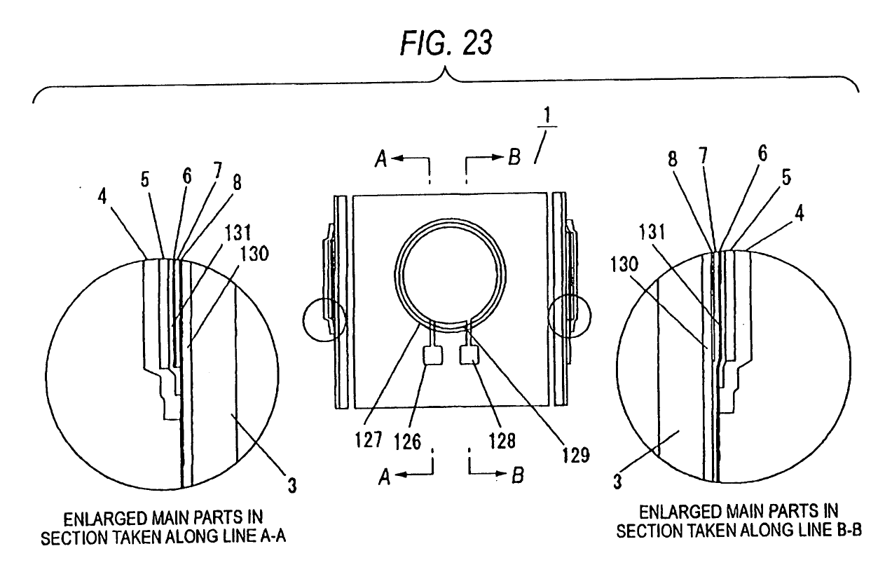

Now, a structure for guiding electrodes will be described by referring to the drawings. FIG. 23 is a diagram showing a wiring structure of a form variable mirror element according to the present invention.

Reference numeral 126 designates a second electrode terminal for connecting a second electrode film 8 to a driving circuit. The second electrode film 8 is connected to the second electrode terminal 126 by a guide line 127.

Reference numeral 128 designates a first electrode terminal for connecting a first electrode film 6 to the driving circuit. Further, the first electrode film 6 is connected to the first electrode terminal 128 by a guide line 129.

Reference numeral 130 designates an insulating film for insulating the second electrode film 8, the second electrode terminal 126 and the guide line 127 from a base 3.

Reference numeral 131 designates an insulating film for insulating the first electrode film 6 from an elastic sheet film 5.

As a reflection mirror film 4 of the form variable mirror element 1 of this embodiment, a dielectric multi-layer film is employed. The dielectric multi-layer film functions as an insulating film by itself.

The second film 8, the second electrode terminal 126 and the guide line 127 are made of the same film coming into close contact with the insulating film 130.

The first electrode film 6, the first electrode terminal 128 and the guide line 129 are formed with the same film in close contact with a piezoelectric film 7.

At this time, in order to insulate the first electrode film 6 from the guide line 129, the piezoelectric film 7 is used as an insulating film. Thus, a film of the same layer as that of the second electrode terminal 126 or the guide line 127 is not provided below the guide line 129 or the first electrode terminal 128.

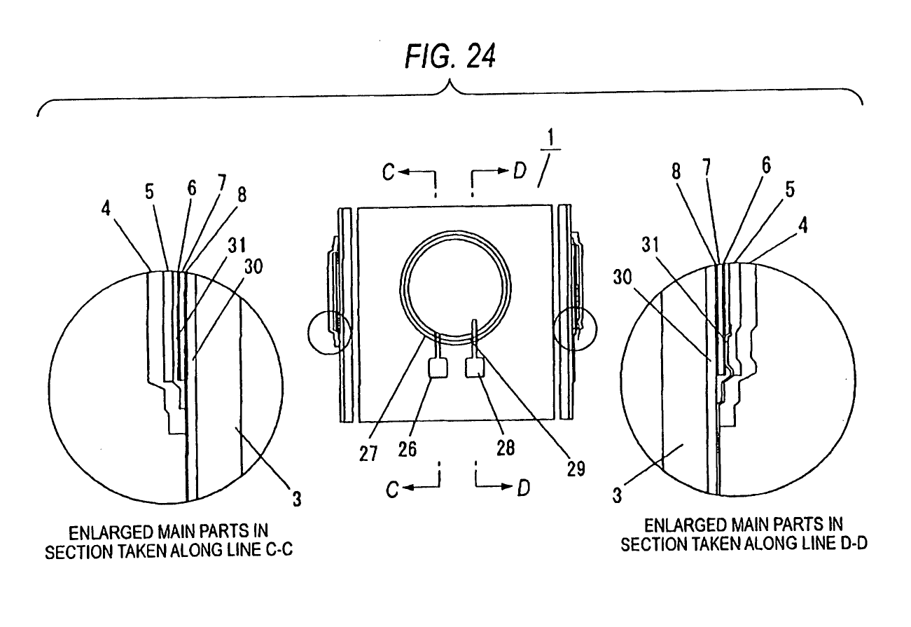

Another embodiment of a structure for guiding electrodes will be described by referring to the drawings. FIG. 24 is a diagram for specifically showing a structure for guiding the electrodes of the form variable mirror element of the present invention.

Since the second electrode film 8 is guided to the second electrode terminal 126 in the same manner (as the first embodiment of the structure for guiding electrodes), an explanation thereof is omitted.

In a structure for guiding the first electrode film 6 to the first electrode terminal 128, a through hole is formed in the insulating film 131 on the piezoelectric film to connect a guide line.

Accordingly, in this embodiment, the film of the first electrode film 6 does not form the same layer as that of the first electrode terminal 128 and the film of the guide line 129.

As described above, according to the form variable mirror element of the present invention, the extremely thin form variable mirror element and the form variable mirror unit in which an amount of deformation is large even under low applied voltage with a simple structure can be eminently effectively provided.

Further, according to the method for producing the form variable mirror element of the present invention, the method for producing the form variable mirror element in which an amount of deformation is large even under low applied voltage that has no process for connecting the thin base to a part below the form variable part can be outstandingly effectively obtained. At the same time, the form variable mirror element with a very high reflection factor can be outstandingly effectively provided.

Furthermore, according to the optical pick-up of the present invention, the optical pick-up on which the wave surface aberration correcting means is mounted can be eminently effectively provided without greatly changing the structure of the optical system of a usual optical pick-up.

1. A form variable mirror element comprising:
a form variable part, including a piezoelectric film, a first electrode film and a second electrode film, which supply voltage to the piezoelectric film and, a reflection mirror film provided in the piezoelectric film; and
a base, which supports the form variable part, wherein the form variable part is provided with an elastic unit which gives an elasticity to the form variable part.

2. The form variable mirror element according to claim 1, wherein the first electrode film is provided on one surface of the piezoelectric film and the second electrode film is provided on the other surface.

3. The form variable mirror element according to claim 1, wherein at least one of the reflection mirror film, the first electrode film, the second electrode film and the base has the elasticity as the elastic unit.

4. The form variable mirror element according to claim 1, wherein an elastic sheet film is separately provided as the elastic unit and the elastic sheet film is provided between the base and the reflection mirror film.

5. The form variable mirror element according to claim 1, wherein an area of the base for supporting the form variable part is smaller than the area of the base.

6. The form variable mirror element according to claim 5, wherein the reflection mirror film provided in the form variable part is extended onto the base and the reflection mirror film provided in the form variable part is formed integrally with the reflection mirror film provided in a part in which the form variable part is not disposed.

7. The form variable mirror element according to claim 1, wherein the outer form of the form variable part is at least one form selected from a circular form, an elliptic form, a rectangular form, a polygonal form and a triangular form.

8. The form variable mirror element according to claim 1, wherein a plurality of form variable parts are provided on one base.

9. The form variable mirror element according to claim 4, wherein the elastic sheet film is made of a resin and the Youngs' modulus of the resin is located within a range of 1/100 to 1/10 as high as the Youngs' modulus of the piezoelectric film.

10. The form variable mirror element according to claim 1, wherein the form variable part has a diaphragm structure formed in an opening part of a hollow part of the thin base.

11. The form variable mirror element according to claim 10, wherein the total of an internal stress of the films forming the form variable part is in a state of compressed and tensile stress and an amount of deformation of the form variable part due to the internal stress is ¼ or less as long as the wavelength of light used for a PV value.

12. The form variable mirror element according to claim 11, wherein the elastic sheet film is provided in the form variable part as the elastic unit and the thickness of the elastic sheet film is different depending on areas.

13. The form variable mirror element according to claim 11, wherein the thickness of the piezoelectric film provided in the form variable cart is different depending on areas.

14. A form variable mirror unit
comprising: a form variable mirror element according to claim 1 and an actuator for moving the form variable mirror element itself, wherein the form variable mirror element is formed integrally with the actuator.

15. A method for producing a form variable mirror element comprising the steps of:
bonding a thin base on which a piezoelectric film and a first electrode film or a second electrode film are formed to a base including a resin and
etching the thin base.

16. A method for producing a form variable mirror element comprising:
a diaphragm forming step of etching a thin base to form a diaphragm and a reflection mirror film forming step of forming
a reflection mirror film after the diaphragm forming step.

17. The method for producing a form variable mirror element according to claim 16, wherein the diaphragm forming step of etching the thin base to form the diaphragm includes two stages of etching process including a first process of etching a half or more of the thickness of the thin base and a second process of etching the rest of the thickness part.

18. An optical pick-up which is a device for recording or reproducing data on an optical disk and has a unit for correcting a wave surface aberration of a laser beam, wherein at least one of the form variable mirror element according to claims 1 and the form variable mirror unit according to claim 14 is mounted.

19. An optical pick-up according to claim 18, wherein at least one of the form variable mirror element according to claims 1 and the form variable mirror unit according to claim 14 is used as the wave surface aberration correcting unit.
